(19) United States
(12) Patent Application Publication
(10) Pub. No.: US 2014/0223318 A1
(43) Pub. Date: Aug. 7, 2014

(54) SYSTEM AND METHOD FOR AGGREGATING ONLINE IMAGES AND MANAGING IMAGE STREAMS

(71) Applicant: Drew Pefferle, Roseville, CA (US)

(72) Inventor: Drew Pefferle, Roseville, CA (US)

(21) Appl. No.: 13/760,038

(22) Filed: Feb. 5, 2013

(51) Int. Cl. G06F 3/0481

(52) U.S. Cl. CPC G06F 3/0481
USPC 715/738

(57) ABSTRACT

A system and method for aggregating online images and managing image streams are disclosed. A particular embodiment includes: enabling a user to create a custom image album via a computer-implemented user interface, the image album including a link to at least one social network account having a plurality of images stored therein; providing an application on a rendering device to support an image stream; and using a data processor to automatically, periodically, and directly stream the plurality of images via a network from the social network account to the application on the rendering device of a user platform.

### TECHNICAL FIELD

This patent application relates to a system and method for use with networked computer systems, according to one embodiment, and more specifically, to a system and method for aggregating online images and managing image streams.

### BACKGROUND

The content available to networked computer users has increased significantly in recent years. Content sources accessible on public data networks can include search engines, social networks, personal websites or blogs, email hosts, businesses, or any of a variety of providers of network transportable digital content. Often, these content sources can include images, photographs, drawings, graphics, and the like. Increasingly, organizations and people are using various network sites, on-line communities, or social network sites for interacting with each other. Social networks have gained in popularity as people have started to use content sources and content itself as a basis for connecting with each other. Various conventional sites, such as facebook.com, twitter.com, linkedin.com, pinterest.com, and youtube.com are just a few examples of the community of content sources and social networks that have grown in popularity.

As the numbers and size of the content sources and social networks expand, it becomes more difficult to follow favored imagery across the community of content sources and social networks. Additionally, it is difficult to move this imagery to external devices in a real-time manner. As a result, users are not able to benefit from the continually changing imagery available from their community of content sources and social networks. Currently, the majority of internet users tend to upload their digital photos of special and memorable events to a social community (e.g., Facebook) to share with friends and family; however, due to a lack of viewing options, only a small percentage of those users actually go back to enjoy these pictures or even remember that they exist.

### SUMMARY

An example embodiment provides an easy-to-use application that seamlessly integrates with a social community (e.g., Facebook) and the images or image albums posted on a social community account. From the application, users can build their own image albums and then stream images from the created image albums to various devices, such as computers, computer screensavers, tablets, TV's, digital picture frames, and/or other rendering devices. The example embodiment allows users to follow people, albums or particular images from their own social community accounts and/or their friends' social community accounts. The example embodiment allows users to create a custom image stream from an image source of the user's choosing. This custom image stream can then be sent to others to view via a browser-based player, a screensaver application, and/or a rendering device application. The user can download the screensaver application or the device application to their computing platform or their digital picture viewing device. The rendering device can also have the screensaver application or the device application pre-installed on the device. The browser player, screensaver application (app) or the device application (app) can then stream or download the user's chosen images or the user's friend's social community images (depending on settings) to the user's screensaver or rendering device. These chosen images can stream directly from the chosen social community account to the browser player, the screensaver app, or the device app. The images update automatically and dynamically on the browser player, the screensaver app, or the device app and the corresponding rendering device according to the user-defined settings. Other embodiments include a capability for users to stream their images to Smart TVs, DVD apps, GoogleTV™, and AppleTV™ via a device app. In embodiments for streaming images to a digital picture frame, the system of an embodiment synchronizes (syncs) the digital picture frames with chosen images from the social community account, thereby alleviating this tedious process. Little effort is necessary for keeping images current on a digital picture frame. Setting up the digital picture frame can be performed from the easy-to-use application. A wireless network can be used to enable data communication between the easy-to-use application and the digital picture frame.

In one embodiment, a Really Simple Syndication (RSS) feed is used to stream the chosen images to the specified devices. Because of the large amount of changing content, users often seek mechanisms that help them manage, access, and use the content sources that interest them. One such mechanism uses an RSS feed. Generally, RSS provides web content or summaries of web content together with links to the full versions of the content, and other meta-data. This information is delivered as an Extensible Markup Language (XML) file typically called an RSS feed, web feed, RSS stream, or RSS channel. RSS feeds enable a user to subscribe to a content provider's website, or the like, and receive a content feed in a defined format. Other services can provide an alert indicating when a change to the content has occurred. The various embodiments can use RSS feeds to send or receive an updated set of images from a specified content source to a specified rendering device.

In another embodiment, a JSON (JavaScript Object Notation) format can be used to stream the chosen images to the specified devices. JSON is a text-based open standard designed for human-readable data interchange. The JSON format is often used for serializing and transmitting structured data over a network connection. JSON can be used in an embodiment to transmit data between a server, device, or application, wherein JSON serves as an alternative to XML.

In a particular embodiment, a host or host website is used to provide access to the easy-to-use application described herein. The host can be accessed using conventional means for accessing an internet website. In the particular embodiment, the host does not need to store any images or image albums. Rather, all images are streamed live from a selected content source to a selected user rendering device. In one embodiment, all images are streamed live via an RSS or JSON feed using a social community (e.g., Facebook) Application Programming Interface (API) between a social community account and a chosen rendering device. The host simply stores the data for managing the image stream, such as data identifying the images to display, data specifying when to display the images, and data specifying how to display the images. The host can relay this information live on the fly to the browser player, the screensaver app, or the device app. The browser player, the screensaver app, or the device app can then communicate directly with the social community site (or other content source) via the APIs to get the desired images in the order specified by use of the host site.

Another embodiment also provides a Mobile Event Application, which allows users and businesses to create events or event albums that provide other users the capability of posting images directly to the event album. This is a very innovative tool for the hosts of special events, such as weddings, concerts, birthday parties, sports events, etc. By providing permission to the guests of the events to upload images directly to the event albums, at the end of the event, the album will comprise a compilation of each guest's memories and footage from different user's perspectives.

### BRIEF DESCRIPTION OF THE DRAWINGS

The various embodiments is illustrated by way of example, and not by way of limitation, in the figures of the accompanying drawings in which:

FIG. 1 illustrates an example embodiment of a system and method for aggregating online images and managing image streams;

FIG. 2 illustrates a system diagram of an example embodiment;

FIGS. 3 and 4 illustrate an example of a user interface enabling a user at a user platform to build and configure one or more image albums on one or more content sites;

FIG. 5 illustrates an example of a user interface enabling a user at a user platform to view and configure one or more image sets from one or more image albums sourced from one or more content sites:

FIG. 6 illustrates a system diagram in an example embodiment using an advertising (ad) content server,

FIG. 7 illustrates a system diagram of the user services module in an example embodiment;

FIG. 8 illustrates another example embodiment of a networked system in which various embodiments may operate;

FIG. 9 is a processing flow chart illustrating an example embodiment of a system for aggregating online images and managing image streams as described herein; and

FIG. 10 shows a diagrammatic representation of machine in the example form of a computer system within which a set of instructions when executed may cause the machine to perform any one or more of the methodologies discussed herein.

### DETAILED DESCRIPTION

In the following description, for purposes of explanation, numerous specific details are set forth in order to provide a thorough understanding of the various embodiments. It will be evident, however, to one of ordinary skill in the art that the various embodiments may be practiced without these specific details.

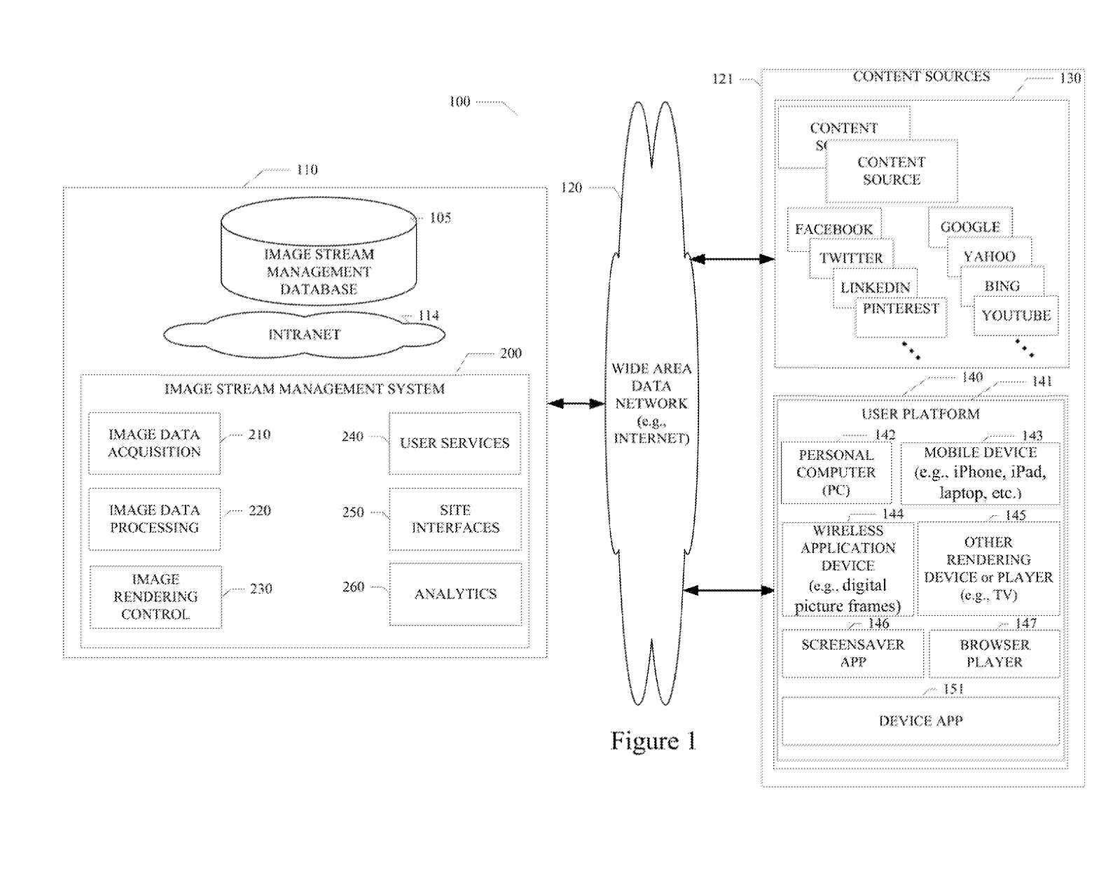

Referring to FIG. 1, in an example embodiment, a system 100 and method for aggregating online images and managing image streams are disclosed. In various example embodiments, an application or service, typically operating on a host site (e.g., a website) 110, is provided to simplify and facilitate custom image album creation and custom image stream management at a user platform 140 from the host site 110. The host site 110 can thereby be considered an image stream management site 110 as described herein. Multiple networked resources 121 can be used by the image stream management site 110 as sources and destinations for the images and image streams managed by the site 110. For example, content sources 130 can provide a plurality of content searching resources, which can be used to search for content using conventional search engines, such as Google™, Yahoo™, Bing™, and the like. Content sources 130 can also be accessed directly using a link or uniform resource locator (URL). Content sources 130 represent the variety of web pages, documents, images, video, audio, media, and other forms of content available via a wide area data network, such as the Internet 120. For example, content sources 130 can include web pages on which a particular image may be shown, listed, or linked.

Content sources 130 can also represent network-accessible sites on which individuals, businesses, organizations, or other entities may create personalized information data sets that provide information about the entity, images related to the entity, and typically a means for communicating with the entity. Such personalized information data sets, often organized on various social network sites or communities (e.g., Facebook), can include photos, graphics, photo albums, animations, video or audio clips, organizational information, product/service information, contact information, historical information, or a wide variety of structured or unstructured information related to a particular entity. Various conventional sites, such as facebook.com, twitter.com, linkedin.com, and pinterest.com are just a few examples of the available content sources 130. It will be apparent to those of ordinary skill in the art that content sources 130 can be any of a variety of networked content providers. It will also be apparent to those of ordinary skill in the art that content sources 130 can include a variety of network sites including, social network sites, data aggregation sites, marketing sites, photo sharing sites, and the like. The image stream management site 110, content sources 130, and user platforms 140 (described below) may communicate and transfer information via a wide area data network (e.g., the Internet) 120. Various components of the image stream management site 110 can also communicate internally via a conventional intranet or local area network (LAN) 114.

Networks 120 and 114 are configured to couple one computing device with another computing device. Networks 120 and 114 may be enabled to employ any form of computer readable media for communicating information from one electronic device to another. Network 120 can include the Internet in addition to LAN 114, wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent between computing devices. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital User Lines (DSLs), wireless links including satellite links, or other communication links known to those of ordinary skill in the art. Furthermore, remote computers and other related electronic devices can be remotely connected to either LANs or WANs via a modem and temporary telephone link.

Networks 120 and 114 may further include any of a variety of wireless sub-networks that may further overlay stand-alone ad-hoc networks, and the like, to provide an infrastructure-oriented connection. Such sub-networks may include mesh networks, Wireless LAN (WLAN) networks, cellular networks, and the like. Networks 120 and 114 may also include an autonomous system of terminals, gateways, routers, and the like connected by wireless radio links or wireless transceivers. These connectors may be configured to move freely and randomly and organize themselves arbitrarily, such that the topology of networks 120 and 114 may change rapidly.

Networks 120 and 114 may further employ a plurality of access technologies including 2nd (2G), 2.5, 3rd (3G), 4th (4G) generation radio access for cellular systems, WLAN, Wireless Router (WR) mesh, and the like. Access technologies such as 2G, 3G, 4G, and future access networks may enable wide area coverage for mobile devices, such as one or more of client devices 141, with various degrees of mobility. For example, networks 120 and 114 may enable a radio connection through a radio network access such as Global System for Mobile communication (GSM), General Packet Radio Services (GPRS), Enhanced Data GSM Environment (EDGE), Wideband Code Division Multiple Access (WCDMA), CDMA2000, and the like. Networks 120 and 114 may also be constructed for use with various other wired and wireless communication protocols, including TCP/IP, UDP, SIP, SMS, RTP, WAP, CDMA, TDMA, EDGE, UMTS, GPRS, GSM, UWB, WiMax, IEEE 802.11x, and the like. In essence, networks 120 and 114 may include virtually any wired and/or wireless communication mechanisms by which information may travel between one computing device and another computing device, network, and the like. In one embodiment, network 114 may represent a LAN that is configured behind a firewall (not shown), within a business data center, for example.

The content sources 130 may include any of a variety of providers of network transportable digital content. Typically, the file format that is employed is Extensible Markup Language (XML), however, the various embodiments are not so limited, and other file formats may be used. For example, data formats other than Hypertext Markup Language (HTML)/XML or formats other than open/standard data formats can be supported by various embodiments. Any electronic file format, such as Portable Document Format (PDF), Joint Photographic Experts Group (JPEG) format, Tagged Image File Format (TIFF), audio/video (e.g., Motion Picture Experts Group Audio Layer 3—MP3, MP4, and the like), and any proprietary interchange format defined by specific content sites can be supported by the various embodiments described herein.

In a particular embodiment, a user platform 140 with one or more client devices 141 enables a user to access image stream management site 110 via the network 120. Client devices 141 may include virtually any computing device that is configured to send and receive information and/or images over a network, such as network 120. Such client devices 141 may include portable or mobile devices 143 such as, cellular telephones, smart phones, display pagers, radio frequency (RF) devices, infrared (IR) devices, global positioning devices (GPS), Personal Digital Assistants (PDAs), handheld computers, wearable computers, tablet computers, laptop computers, integrated devices combining one or more of the preceding devices, and the like. Client devices 141 may also include other computing devices, such as personal computers (PCs) 142, multiprocessor systems, microprocessor-based or programmable consumer electronics, network PC's, and the like. Client devices 141 may also include other computing or imaging devices 144 and/or 145, such as electronic picture frame devices, wireless application devices, rendering devices, players, consumer electronic devices, networked imaging devices, image rendering devices, monitors, televisions (TVs), smart TVs, and the like. As such, client devices 141 may range widely in terms of capabilities and features. For example, a client device configured as a cell phone may have a numeric keypad and a few lines of monochrome LCD display on which only text or simple images may be displayed. In another example, a web-enabled client device may have a touch sensitive screen, a stylus, and a color LCD or plasma display on which text, images, and/or graphics may be displayed. Moreover, the web-enabled client device may include an application enabled to receive and to send wireless application protocol messages (WAP), and/or wired application messages, and the like. In one embodiment, the application is enabled to employ HyperText Markup Language (HTML), Dynamic HTML, Handheld Device Markup Language (HDML), Wireless Markup Language (WML), WMLScript, JavaScript, EXtensible HTML (xHTML), Compact HTML (CHTML), and the like, to display images and transfer messages with relevant information.

Client devices 141 may also include at least one client application that is configured to receive content or messages from another computing device via a network transmission. In one embodiment, the client application can include a screensaver application 146. In general, screensaver apps for displaying images on a display screen during idle times are well known. In an embodiment described herein, the screensaver app 146 is reconfigured to automatically and periodically communicate directly with one or more content sources 130 via the network 120 to download images or receive an image stream directly from the one or more content sources 130 under the control and configuration of the image stream management site 110. The received images can then be displayed by the screensaver app 146 on one or more rendering devices of the user platform 140 as configured by the user. Similarly, the user platform 141 can include a browser player 147 that can also be used to download or stream images directly from the one or more content sources 130 under the control and configuration of the image stream management site 110. Standard browser players are well-known in the conventional technology. In another embodiment, a device app 151 can also be used to download or stream images directly from the one or more content sources 130 under the control and configuration of the image stream management site 110. In general for the various embodiments, the user platform 140 requires a software component (e.g., a browser player, a screensaver app, or device app) plus a hardware component (e.g., a display device, a digital picture frame, a TV, or other rendering device). The software components and the hardware components for rendering the images can be paired in a variety of ways. Once a pairing of software/hardware components is established under control of the user, the pairing of software/hardware components can be configured to stream images via RSS (or JSON), locally download, store, and display the images, or both. The browser player is typically part of any conventional browser. The screensaver app or the device app can be downloaded to a rendering device or pre-installed in the rendering device. In the various embodiments described herein, the image stream management site 110 does not need to store the images downloaded or streamed to the one or more rendering devices of the user platform 140.

Referring still to FIG. 1, image stream management site 110 (host site) of an example embodiment is shown to include an image stream management system 200, intranet 114, and image stream management database 105. Image stream management system 200 can include image data acquisition module 210, image data processing module 220, image rendering control module 230, user services module 240, site interface module 250, and analytics module 260. Each of these modules can be implemented as software components executing within an executable environment of the image stream management system 200 operating on host site 110. Each of these modules of an example embodiment is described in more detail below in connection with the figures provided herein.

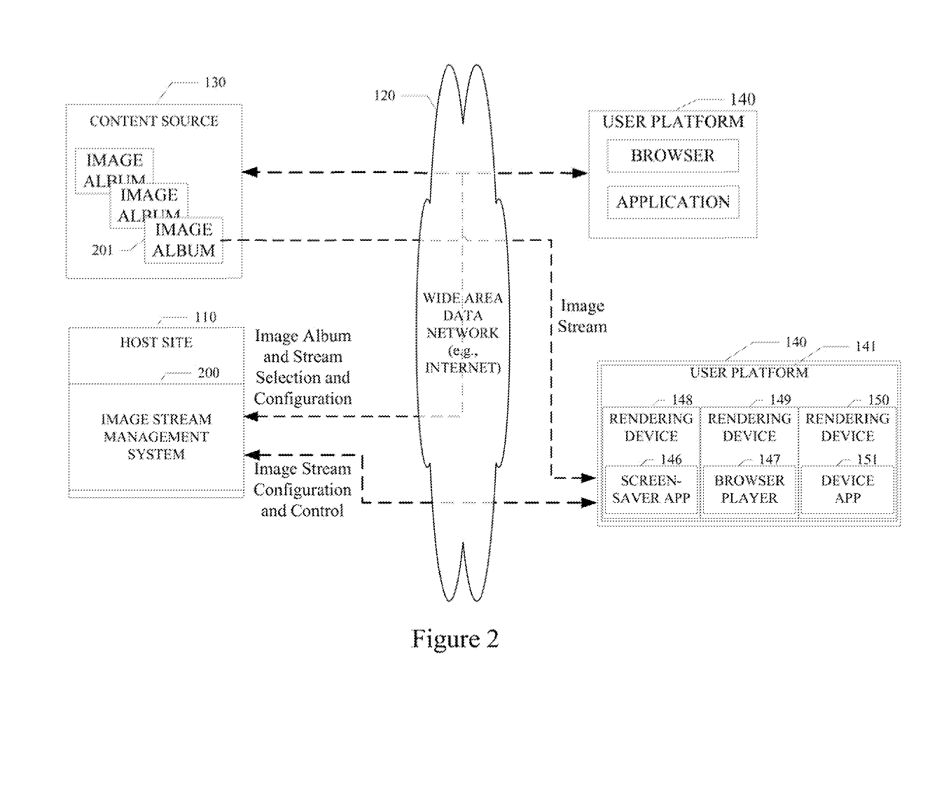

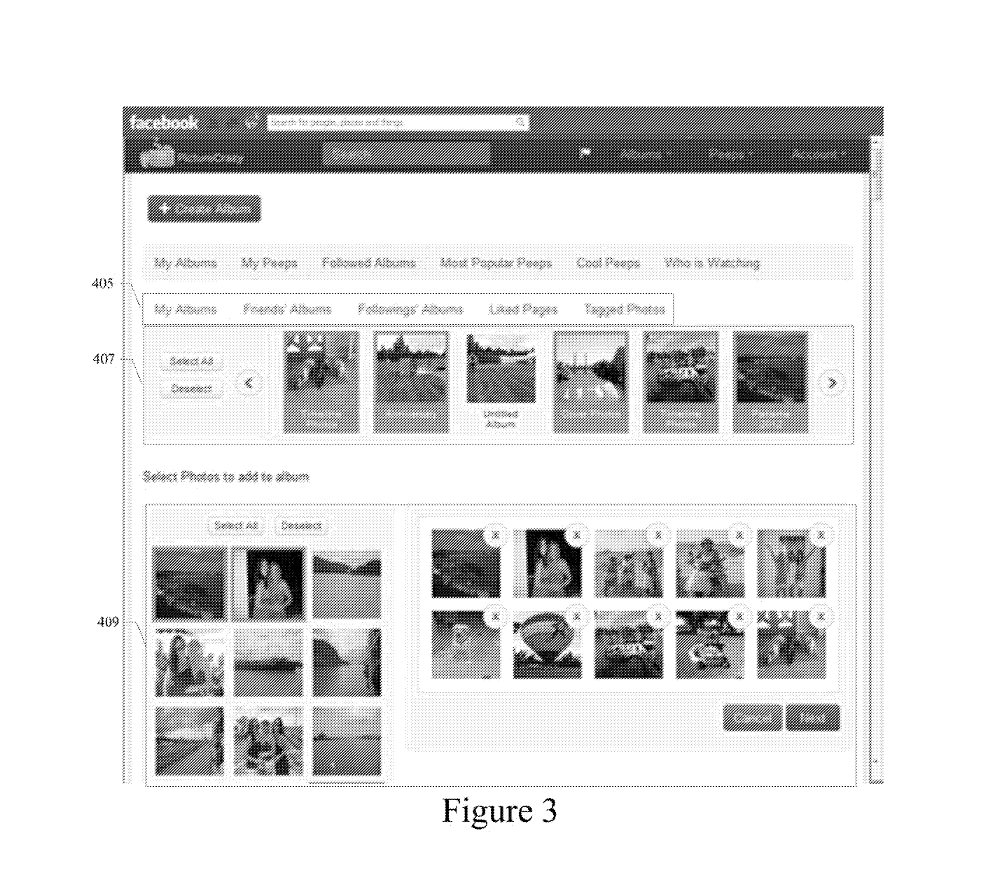

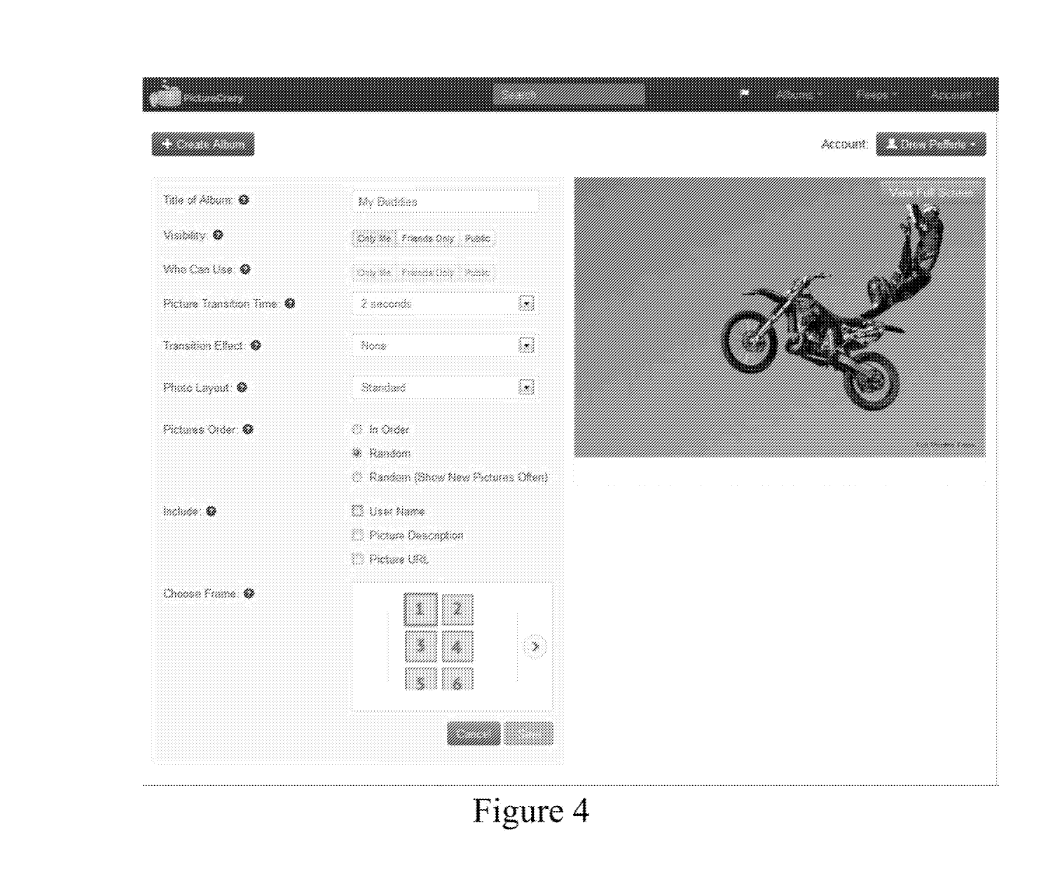

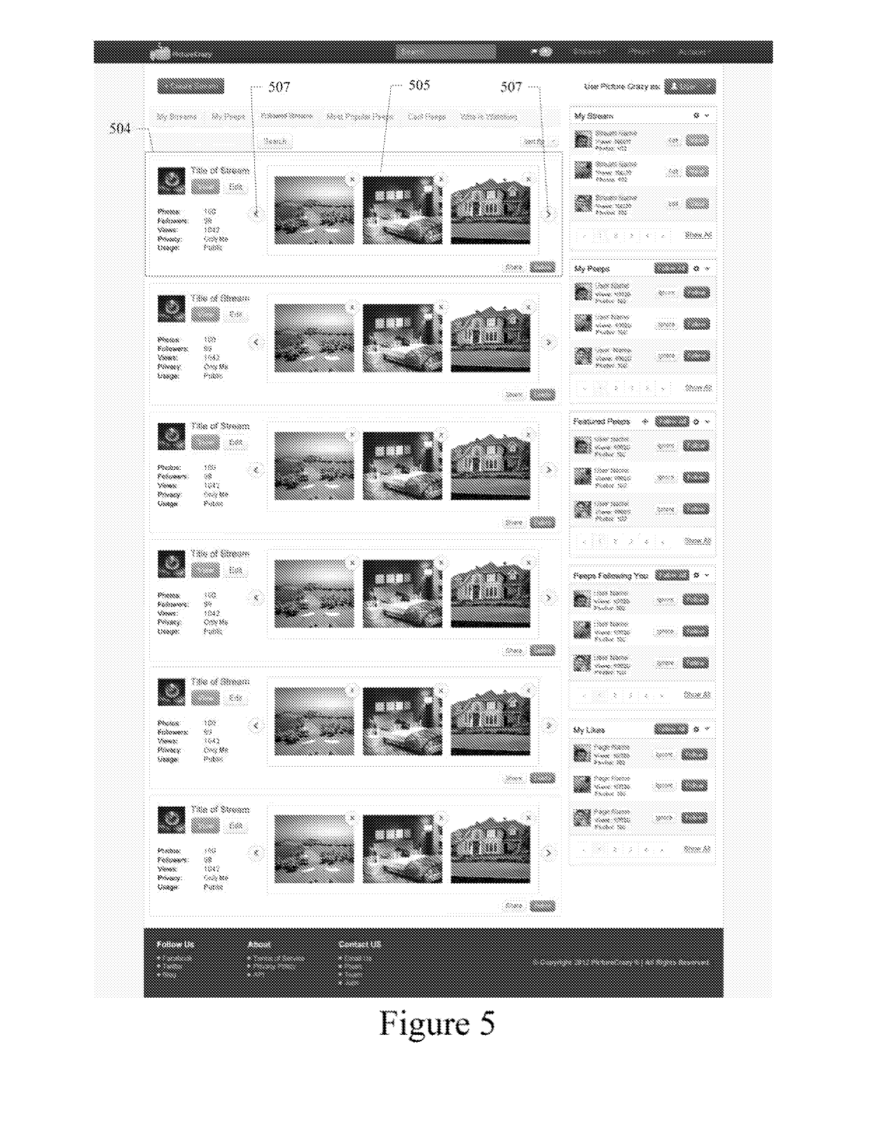

Referring now to FIG. 2, a system diagram in an example embodiment is illustrated. As described above, users can employ a conventional web browser (e.g., Internet Explorer™, Chrome™, Firefox™, etc.) and/or a client application, described in more detail below, in concert with the host site 110 to build their own custom image albums on one or more content sites 130. A sample user interface, shown in FIGS. 3 and 4 and described below, illustrates an example of a user interface enabling a user at user platform 140 to build and configure one or more custom image albums 201 on one or more content sites 130. The custom image albums represent a set of related images assembled or linked by the user. In one embodiment, the custom image album includes a link to at least one social network account having a plurality of images stored therein. The user at user platform 140 can also configure one or more image streams to stream images from the created image albums to various rendering devices (e.g., rendering devices 148, 149, or 150 shown in FIG. 2 and denoted herein as rendering devices 148-150) on user platform 140, such as computers, computer screensavers, tablets, TV's, digital picture frames, and/or other rendering devices. The image data acquisition module 210 and the image data processing module 220 of an example embodiment can be used to manage the creation, configuration, and control of the image albums and image streams. The image rendering control module 230 of an example embodiment can be used to configure and control the rendering device applications and the presentation of the image streams on the various rendering devices 148-150 on user platform 140. A sample user interface, shown in FIG. 5 and described below, illustrates an example of a user interface enabling a user at a user platform 140 to view and configure one or more image sets from one or more image albums sourced from one or more content sites 130 and streamed or downloaded to various rendering devices 148-150 on user platform 140. As part of the configuration of the one or more image streams, a screensaver app 146, a browser player 147, or a device app 151 is configured to automatically, periodically, and directly access a particular image album 201 on a particular content site 130 to stream the images therein to a rendering device 148-150 on the user platform 140. The operation of the screensaver app 146, the browser player 147, or the device app 151 is configured and controlled by the image stream management system 200 at the host site 110.

As described in more detail below in connection with FIGS. 4 and 5, an example embodiment allows users to include images from their own collections or the image collections of others. For example, a user can assemble an image album 201 from the user's Facebook account as one of the content sources 130. The image album 201 can also include images from the Facebook accounts of other users who have been friended or followed using the standard features provided by Facebook or other social network sites. Similarly, image albums 201 can be created from image collections on other social network sites or other content sites 130. In this manner, the various embodiments described herein allow a user to follow people, entities, image albums, and/or particular images from their own social community accounts and/or their friends' social community accounts.

Referring again to FIG. 2, once one or more image albums 201 are created, the example embodiment allows users to create and configure one or more custom image streams from image sources of the user's choosing. The image sources can be linked with one or more image albums 201 residing on one or more content sources 130. As shown in FIG. 2, the custom image stream can be transferred from a selected image album 201 at content source 130 to a rendering device 148-150 on the user platform 140. A browser player 147, a screensaver app 146, or a device app 151, as configured by image stream management system 200, can facilitate the transfer of the image stream directly from the content source 130 to the user platform 140 device. In a particular embodiment, the browser player 147 can be a software module, such as a standard browser-based player, executable in a computing environment of a particular rendering device 149. Alternatively, the user can download a screensaver app 146 to their user platform 140 or their particular rendering device 148 (e.g., a digital picture frame). The screensaver app 146 can also be pre-installed in the particular rendering device 148. The screensaver app 146 can also be a software module executable in a computing environment of a particular rendering device 148. The screensaver app 146 can then stream or download the user's chosen images or the user's friend's social community images (depending on settings) to the user's screensaver on an associated rendering device 148. In another embodiment, the user can download a device app 151 to their user platform 140 or their particular rendering device 150 (e.g., a digital picture frame, smart TV, or the like). The device app 151 can also be pre-installed in the particular rendering device 150. The device app 151 can also be a software module executable in a computing environment of a particular rendering device 150. The device app 151 can then stream or download the user's chosen images or the user's friend's social community images (depending on settings) to the user's associated rendering device 150. These chosen images can be streamed directly from the selected social community account at content source 130 via network 120 to the browser player 147, the screensaver app 146, or the device app 151 using conventional data streaming technologies (e.g., RSS or JSON). In one embodiment, a Really Simple Syndication (RSS) feed is used to stream the chosen images to the specified rendering device 148-150. As the images are streamed to the configured rendering device 148-150, the images update automatically and dynamically on the rendering device 148-150 as facilitated by the browser player 147, the screensaver app 146, or the device app 151 according to the user-defined settings. By use of various embodiments, users can stream or download their selected images and/or image albums to various rendering devices 148-150, including Smart TVs, DDV apps, GoogleTV™, and AppleTV™, to name a few examples. In embodiments for streaming images to a digital picture frame (e.g., as another example of rendering device 148-150), the browser player 147, the screensaver app 146, or the device app 151 under control of the image stream management system 200 of an embodiment synchronizes (syncs) the images displayed on the digital picture frame with the chosen images from the social community account of a content source 130, thereby alleviating this tedious process. By virtue of the various embodiments described herein, little effort on the part of the user is necessary for keeping images current on a digital picture frame or other rendering device. Further, the use of the browser player 147, the screensaver app 146, or the device app 151 under control of the image stream management system 200 of an example embodiment enables the user to configure the digital picture frame and the images displayed thereon from the easy-to-use application, which is in network data communication with the rendering device 148-150. In one embodiment, the rendering device 148-150 can use a standard wireless network data interface to communicate with network 120. In other embodiments, the rendering device 148-150 can communicate with the network 120 via a standard wired network data interface.

In a particular embodiment, the host 110 is used to provide access for a user at user platform 140 to the image stream management system 200 of an example embodiment, which hosts or facilitates the easy-to-use application described herein. In one embodiment, the entire application can be hosted at site 110. In other embodiments, the application can be split with a portion operating on the host site 110 and a portion operating on the user platform 140. The image stream management system 200 can be accessed using any conventional means for accessing an internet website via network 120. In the particular embodiments described herein, the host 110 does not need to store any images or image albums. Rather, all images are streamed live from a selected content source 130 to a selected user rendering device 148-150. In one embodiment, images can be streamed live via an RSS or JSON feed using a social community (e.g., Facebook) Application Programming Interface (API) between a social community account and a chosen rendering device 148-150. The host 110 simply stores the data for managing the image stream, such as data identifying the images to display, data specifying when to display the images, and data specifying how to display the images on the rendering device 148-150. The host 110 can relay this information live on the fly to the browser players, screensaver apps, and/or device apps of the rendering devices 148-150. The browser players, screensaver apps, and/or device apps of the rendering devices 148-150 can then communicate directly with the social community site (or other content sources 130) via the APIs to get the desired images in the order specified by use of the host site 110. In an example embodiment, the image data acquisition module 210 can use the site interfaces module 250 to obtain the appropriate APIs for each of the social community sites or other content sources 130 from which the browser players, screensaver apps, and/or device apps of the rendering devices 148-150 obtain images.

FIGS. 3 and 4 illustrate an example of a user interface enabling a user at a user platform 140 to build and configure one or more image albums on one or more content sites 130. Referring to FIG. 3, a user is presented with several options 405 for sourcing images or image albums when creating a new image album. In particular, when creating a new image album, the user can choose to include: 1) selected images from the user's own image collections or albums, 2) selected images from an image collection or album of a friend of the user, 3) selected images from an image collection or album of another user, entity, or group being followed by the user creating the new image album, 4) images that appear on pages the user has previously “liked”, or 5) images the user has previously tagged. In one embodiment, a friend of the user is defined as another user in a friend relationship with the user as established using the well-known “Friend” functionality (or equivalent functionality) provided by social network sites, such as Facebook™. Similarly, a followed user, entity, or group is defined as a user, entity, or group in a followed relationship with the user creating an album as established using the well-known “Follow” functionality (or equivalent functionality) provided by social network sites, such as Facebook™ or Twitter. The action of “liking” a page is also performed using the well-known “Like” functionality (or equivalent functionality) provided by social network sites, such as Facebook™ or Pinterest™. Finally, the action of tagging an image or photo is a standard feature provided on a variety of sites. The image stream management system 200 can use the APIs provided by the various social network sites to gain access to the image collections and image albums in the user's social network account. Similarly, the image stream management system 200 can use the APIs provided by the various social network sites to obtain the identities of “friends”, “followers”, “liked” pages and the images related thereto. Thus, the user creating the new image album can select from a variety of sources of images.

As shown in areas 407 and 409 of FIG. 3, the user is presented with thumbnails of each of the images in a selected image collection or image album. The user can select or deselect desired images by manipulation of a conventional pointing device, mouse, tactile surface, or other interface device relative to the displayed image thumbnails. As a result, the user can pull specific images from a variety of sources for inclusion in a newly created image album. The user can thereby select the specific images to add to an album. In example embodiment, users can include images from their own collections or the image collections of others. For example, a user can assemble an image album from the user's Facebook™ account as one of the content sources 130. The newly created image album can also include images from the Facebook™ accounts of other users who have been friended or followed using the standard features provided by Facebook™ or other social network sites. Similarly, image albums can be created from image collections on other social network sites, other content sites 130, and/or combinations thereof. As a result, the user can choose images from multiple social network albums or any combination thereof. The user can choose images from the user's personal image collection, a friend's image collection, an image collection associated with a specified group, or fan page of photo images or any combination thereof. Additionally, the user can specify an ordering in which the images are ultimately displayed. Because the various embodiments enable the user to create an image album that can source images from a social network account (e.g., the user's account, a friend's account, a followed user's account, a group's account, etc.), the embodiments described herein allow a user to follow people, entities, particular image albums, and/or particular images from their own social community accounts and/or their friends' social community accounts. As the images in these social community accounts change or are augmented, the screensaver app 146, the browser player 147, or the device app 151 will automatically pick up these new images as part of the image streaming described in more detail below. As a result, the newly created image album can connect or link the user to other users or groups and enable the user to view the updating image collections of the other users or groups without having to constantly update the image album or stream configuration settings.

Referring now to FIG. 4, a sample user interface illustrates the image album configuration parameters or settings the user can manipulate in an example embodiment as part of the image album creation or configuration process. For example, as shown in FIG. 4, the user can specify a title of the image album and specify the visibility constraints on the image album. For example, the user can specify that the image album is authorized for viewing only by the user him/herself, for viewing by friends only, or for viewing by all. Similarly, the user can specify that the image album is authorized for usage only by the user him/herself, for usage by friends only, or for use by all. Usage of the image album can include the copying or linking of the images in the image album into other image albums. As part of the user interface shown in FIG. 4, the user can also manipulate a variety of additional parameters related to image streams connected to a particular image album. The image streaming features of an example embodiment are described in more detail below. All of these parameter selections and the other user-configured data that defines a particular image album are stored in the database 105.

Referring now to FIG. 5, the diagram illustrates an example of a user interface enabling a user at a user platform 140 to view and configure one or more image sets from one or more image albums sourced from one or more content sites 130. In particular, FIG. 5 illustrates a sample set of assembled albums showing the first few images of each album. These images are not stored on a host site 110 server. Rather, the host site 110 and the image stream management system 200 therein direct the browser at a user platform 140 to pull the images in each album from the image source servers (e.g., Facebook servers). This gathering of the images for each album is done on the fly in real time. The set of images for each album represent an image stream that can be streamed or downloaded to a user-selected rendering device 148-150 on the user platform 140. As described in more detail below, the user can also sort and filter the image albums in various ways.

In an example embodiment, a user can configure the set of images from one or more image albums for automatic, periodic, and direct transfer from a particular content source 130 to a selected rendering device 148-150 on the user platform 140. As shown in FIG. 5, the user can select the images in the image set 505 of an image album and arrange the image thumbnails in a desired sequential order. The images in the image set 505 can be scrolled from the left or right using the scroll controls 507 so the entire image set 505 can be viewed by the user. The image ordering can thus be rearranged by selecting and moving the image thumbnails in the image set 505 using conventional mouse controls. The user can also delete particular images from the image set. Additionally, by use of the user interface shown in FIG. 4, the user can also manipulate a variety of parameters related to image streams sourced from particular image albums. For example, the user can specify a picture transition time that is used by the screensaver app 146, the browser player 147, or the device app 151 to determine when to transition to a next image on a particular rendering device 148-150. The user can also specify a type of transition effect to use when transitioning to a next image and a layout for displaying the image. The user can select from among several options for image ordering and can specify the type of captioning used to label the images. The user can also select from among several image framing options. All of these parameter selections and the other user-configured data that defines a particular image stream are stored in the database 105.

The configuration of an image stream can also be used to define the particular rendering device(s) 148-150 of the user platform 140 that are used to display the image stream. For example, the user can specify that the image stream is to be streamed to a digital picture frame device in data communication with the user platform 140. In response to this selection, the image stream management system 200 can use the APIs to configure the screensaver app 146, the browser player 147, or the device app 151 on the selected rendering device to initiate the streaming of the specified image stream directly from the pre-configured image source(s). The image data acquisition module 210 of an example embodiment can use the site interfaces module 250 to obtain the appropriate APIs for each of the content sources 130 from which the screensaver apps 146, the browser player 147 or the device app 151 of the rendering devices 148-150 obtain the images for presentation. In this manner, the images can be automatically streamed to the digital picture frame device of the user platform 140 without requiring the user to manipulate the digital picture frame device directly. The example embodiment thereby enables the image stream management system 200 to integrate with the digital picture frame device and to automatically stream images to the user rendering device without further action by the user. Because the image stream is sourced from a corresponding image album at a content site 130, the presentation of images on the user rendering device will automatically update as new images are added to the image album at the corresponding content site 130.

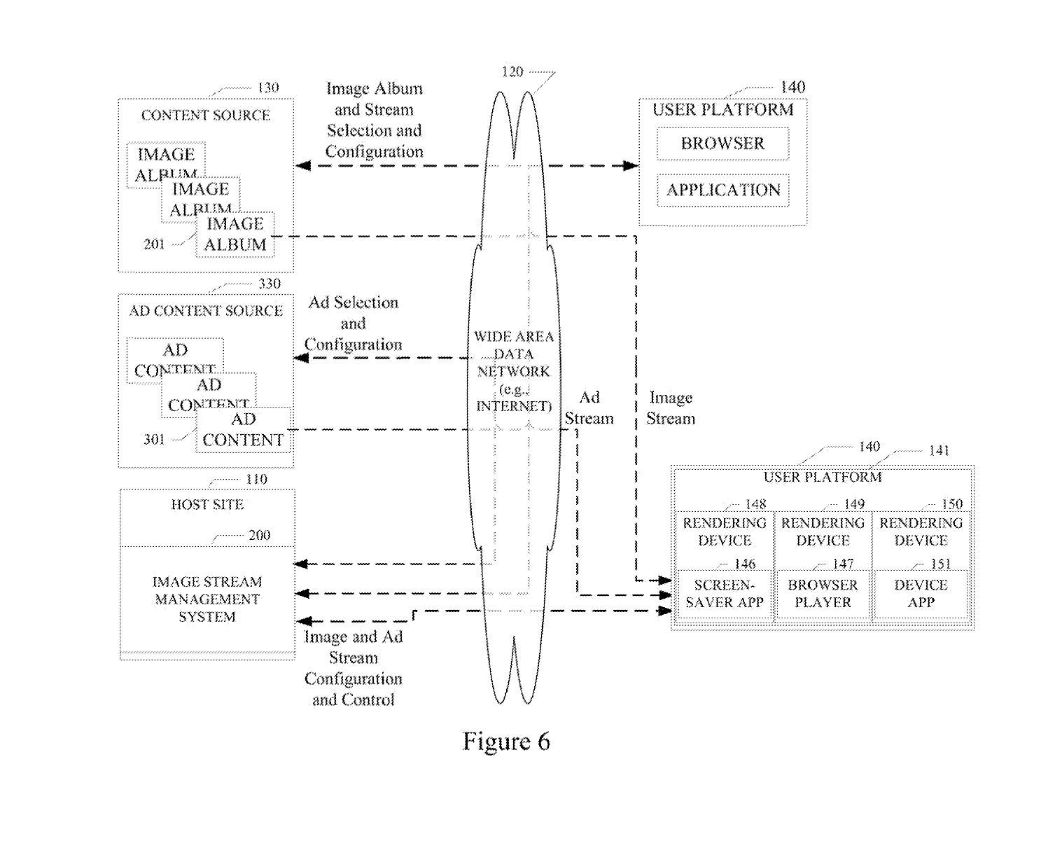

Referring now to FIG. 6, a system diagram illustrates an example embodiment using an advertising (ad) content server 330. In a manner similar to the automatic presentation of image streams on a user rendering device as described above, an example embodiment can also present advertisements (ads) on the user rendering devices 148-150. As shown in FIG. 6, the image stream management system 200 can be in data communication with an ad content source 330 via network 120. Ad content servers are well-known in the art. In an example embodiment, the image data acquisition module 210 can use the site interfaces module 250 to obtain the appropriate APIs for each of the ad content sources 330 from which the screensaver apps 146, the browser player 147, or the device app 151 of the rendering devices 148-150 obtain advertisement impressions. The image stream management system 200 can perform ad selection and configuration based on a variety of factors. For example, the image stream management system 200 can determine user affinity by consulting user profile information, explicit user preference selections, implicitly determined user behavior, and other factors to determine the types of advertising that might be most consistent with a particular user's affinity. The image stream management system 200 can use this information to select particular ads from the ad content source 330. Additionally, the image stream management system 200 can use this information to configure the streaming of these ads to the particular user via the screensaver apps 146, the browser player 147, or the device app 151. The ads can be configured to be presented to the user on the user rendering device along with the images presented as part of a particular image stream. The ads can be configured to be displayed periodically with the image stream, to replace certain images in the image stream, to overlay or tile with the images in the image stream, or to be displayed in a variety of other presentation methods. In this manner, the various embodiments can support targeted advertising.

Another embodiment also provides a Mobile Event Application, which allows users and businesses to create events that provide other users the capability of posting images directly to the event's albums. This is a very innovative tool for the hosts of special events, such as weddings, concerts, birthday parties, sports events, etc. By providing permission to the guests of the events to upload images directly to the event albums, at the end of the event, the image album will comprise a compilation of each guest's memories and footage from different user's perspectives.

In another embodiment, the image stream management system 200 can use appropriate APIs for each of the content sources 130 from which the screensaver apps 146, the browser player 147, or the device app 151 of the rendering devices 148-150 obtain images for presentation. These APIs can be used to obtain information related to the identities of the users who have linked image streams to particular images or image albums. In this manner, a user can obtain information identifying the other users who are viewing or using images or image albums of interest. This information can be included in the analytics information captured by the analytics module 260 of the image stream management system 200 as described in more detail below.

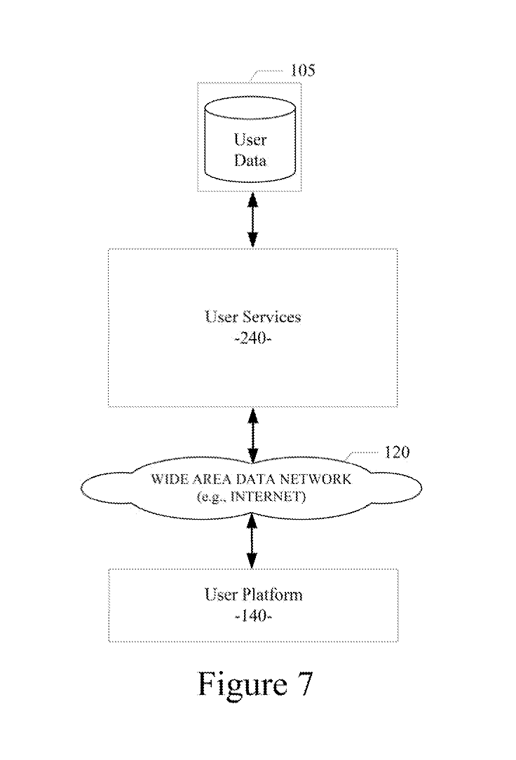

Referring to FIG. 7, a user interface is provided by the user services module 240 and presented to the user via the user platform 140. User services module 240 provides the functionality with which a networked computer user operating from a user platform 140 can become a user/member of an image stream management service of host site 110 and interact with the image stream management services provided by the image stream management system 200. These user image stream management services can be implemented by several functional components provided by the image stream management system 200 as described herein. In an example embodiment, the functional components provided by the user services module 240 can include a user account module and a payment module. The user account module can be used to create and maintain a user account on the host site 110. The user account module can also be used to configure user settings, create and maintain a user/user profile on host site 110, and otherwise manage user data and operational parameters on host site 110. The user data and operational parameters can be retained in database 105. The payment module can be used to submit payment for a user account and for enabling various user services. As described above, the user interface can also be used to enable a user to specify and/or configure one or a plurality of image albums, image streams, and related image album and image stream information (image information). The image information (e.g., image album and stream configuration and setting information, not the image content itself) can also be retained in image rendering control data 105. Additionally, when setting up and/or configuring a user account on host site 110, the user can also provide the authentication credentials necessary to access a user account at a content source 130. The authentication credentials can be used by the image stream management system 200 to obtain access to a user account at a content source 130 and the images or image albums stored therein. The image stream management system 200 can also use the authentication credentials to facilitate access to these content source 130 accounts for the browser player 147, the screensaver app 146, or the device app 151.

In an example embodiment, the analytics module 260 can generate data sets that correspond to the usage (e.g., viewing, downloading, or streaming) of images or image albums relative to a plurality of people or entities associated with the images or image albums. Similarly, the analytics module 230 can also generate data sets that correspond to the aggregated image usage data relative to a plurality of content sources 130. Moreover, the analytics module 230 can also generate aggregate relevance scores that correspond to the aggregated image viewing activity relative to a plurality of people or entities, a plurality of content sources, and a plurality of rendering devices. Thus, the analytics module 230 can generate a variety of relevance score data that corresponds to an online presence across multiple people or entities, multiple content sources, and multiple rendering devices. This generated analytics data can be computed by the analytics module 260 and stored in database 105. This relevance score data can be useful for generating targeting advertising and for generating information for compensating the content sources 130 or for attribution of the content sources 130.

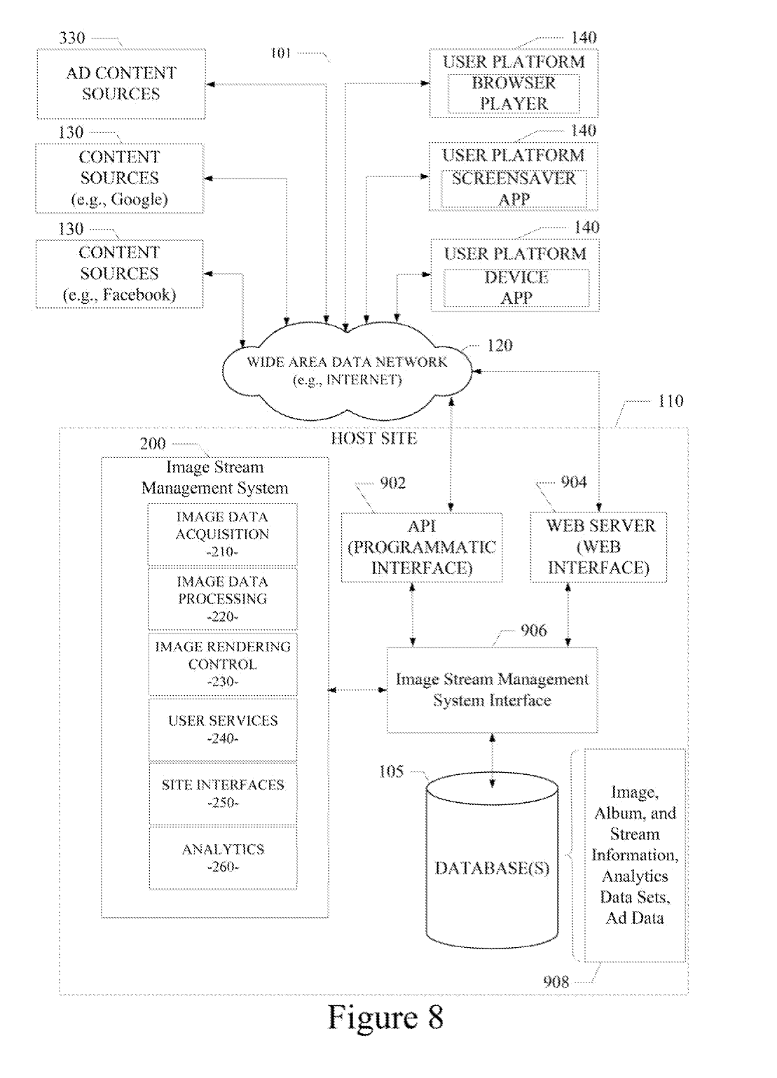

Referring now to FIG. 8, another example embodiment 101 of a networked system in which various embodiments may operate is illustrated. In the embodiment illustrated, the host site 110 is shown to include the image stream management system 200. The image stream management system 200 is shown to include the functional components 210 through 260 as described above. In a particular embodiment, the host site 110 may also include a web server 904 having a web interface with which users may interact with the host site 110 via a user interface or web interface. The host site 110 may also include an application programming interface (API) 902 with which the host site 110 may interact with other network entities on a programmatic or automated data transfer level. The API 902 and web interface 904 may be configured to interact with the image stream management system 200 either directly or via an interface 906. The image stream management system 200 may also be configured to access a data storage device 105 either directly or via the interface 906.

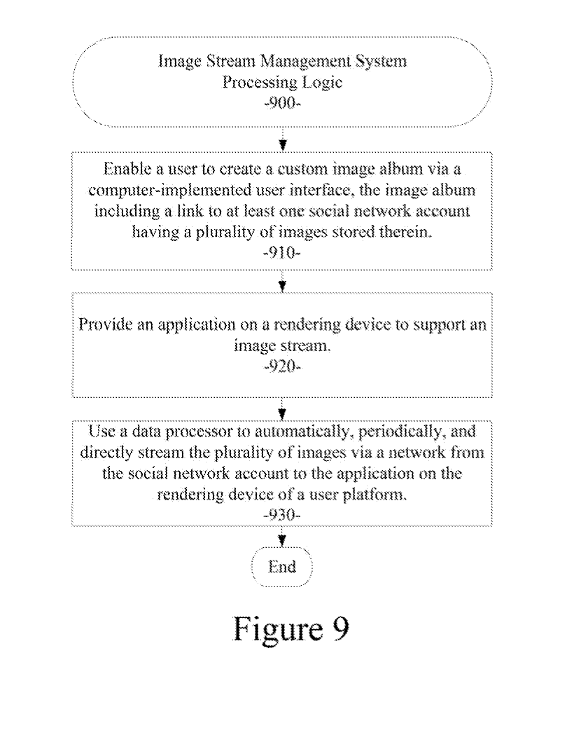

FIG. 9 is a processing flow diagram illustrating an example embodiment of an image stream management system as described herein. The method 900 of an example embodiment includes: enabling a user to create a custom image album via a computer-implemented user interface, the image album including a link to at least one social network account having a plurality of images stored therein (processing block 910); providing an application on a rendering device to support an image stream (processing block 920); and using a data processor to automatically, periodically, and directly stream the plurality of images via a network from the social network account to the application on the rendering device of a user platform (processing block 930).

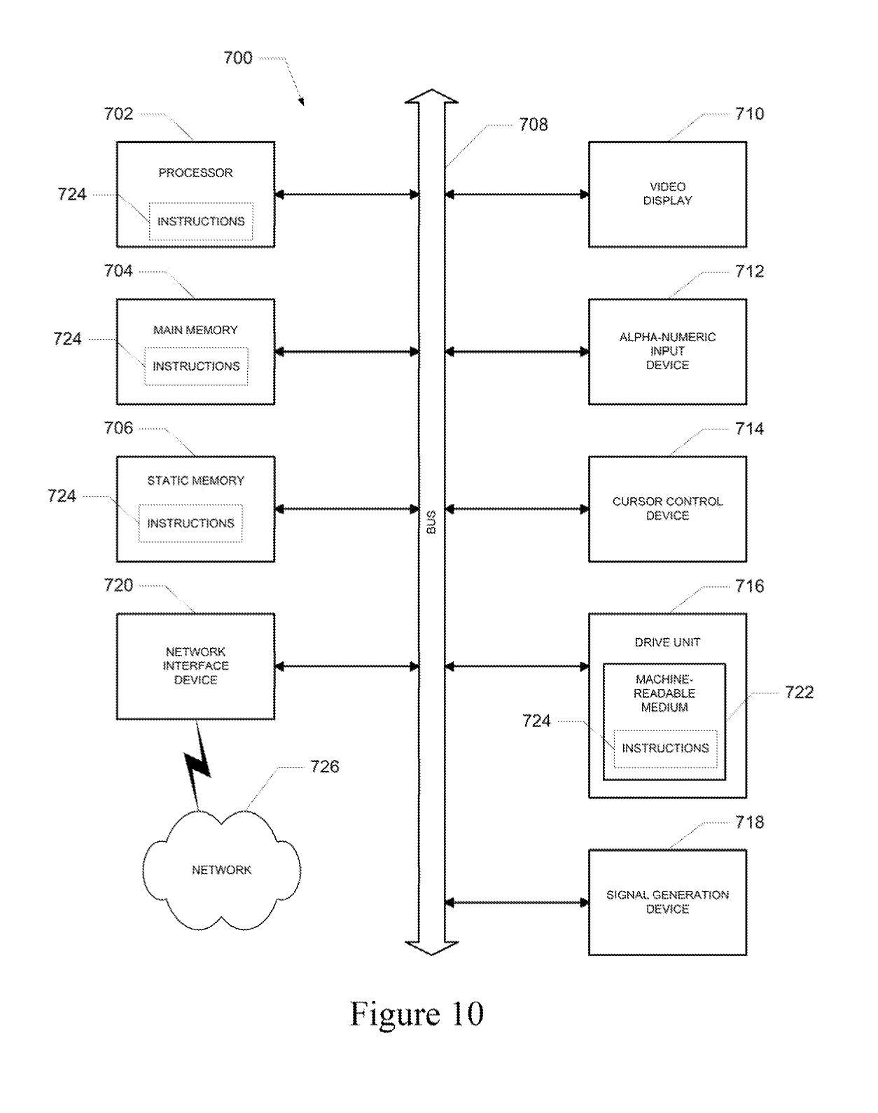

FIG. 10 shows a diagrammatic representation of machine in the example form of a computer system 700) within which a set of instructions when executed may cause the machine to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” can also be taken to include any collection of machines that individually or jointly execute a set (or multiple sets) of instructions to perform any one or more of the methodologies discussed herein.

The example computer system 700 includes a data processor 702 (e.g., a central processing unit (CPU), a graphics processing unit (CPU), or both), a main memory 704 and a static memory 706, which communicate with each other via a bus 708. The computer system 700 may further include a video display unit 710 (e.g., a liquid crystal display (LCD) or a cathode ray tube (CRT)). The computer system 700 also includes an input device 712 (e.g., a keyboard), a cursor control device 714 (e.g., a mouse), a disk drive unit 716, a signal generation device 718 (e.g., a speaker) and a network interface device 720.

The disk drive unit 716 includes a non-transitory machine-readable medium 722 on which is stored one or more sets of instructions (e.g., software 724) embodying any one or more of the methodologies or functions described herein. The instructions 724 may also reside, completely or at least partially, within the main memory 704, the static memory 706, and/or within the processor 702 during execution thereof by the computer system 700. The main memory 704 and the processor 702 also may constitute machine-readable media. The instructions 724 may further be transmitted or received over a network 726 via the network interface device 720. While the machine-readable medium 722 is shown in an example embodiment to be a single medium, the term “machine-readable medium” should be taken to include a single non-transitory medium or multiple media (e.g., a centralized or distributed database, and/or associated caches and servers) that store the one or more sets of instructions. The term “machine-readable medium” can also be taken to include any non-transitory medium that is capable of storing, encoding or carrying a set of instructions for execution by the machine and that cause the machine to perform any one or more of the methodologies of the various embodiments, or that is capable of storing, encoding or carrying data structures utilized by or associated with such a set of instructions. The term “machine-readable medium” can accordingly be taken to include, but not be limited to, solid-state memories, optical media, and magnetic media.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method comprising:
enabling a user to create a custom image album via a computer-implemented user interface, the image album including a link to at least one social network account having a plurality of images stored therein;
providing an application on a rendering device to support an image stream; and
using a data processor to automatically, periodically, and directly stream the plurality of images via a network from the social network account to the application on the rendering device of a user platform.

2. The method as claimed in claim 1 wherein enabling a user to create a custom image album includes enabling the user to select images from an image collection of a friend of the user, the friend of the user being a user in a friend relationship with the user as established on a social network site.

3. The method as claimed in claim 1 wherein enabling a user to create a custom image album includes enabling the user to select images from an image collection of a followed user, entity, or group, the followed user, entity, or group being a user, entity, or group in a followed relationship with the user as established on a social network site.

4. The method as claimed in claim 1 wherein enabling a user to create a custom image album includes enabling the user to select images from an image collection with liked pages, the liked pages being established in connection with a social network site.

5. The method as claimed in claim 1 wherein the rendering device of the user platform is from the group: an electronic picture frame device, a consumer electronic device, a computer, a mobile device, and a television.

6. The method as claimed in claim 1 wherein the application on the rendering device is a screensaver application.

7. The method as claimed in claim 1 wherein the application on the rendering device is a device application.

8. The method as claimed in claim 1 including using the data processor to automatically, periodically, and directly stream a plurality of advertisements via the network to the application on the rendering device of the user platform.

9. The method as claimed in claim 1 including creating an event album and enabling users to post images directly to the event album.

10. The method as claimed in claim 1 including obtaining information identifying other users who are viewing or using images of the custom image album.

11. A system comprising:
a data processor;
a database, in data communication with the processor, for storage of image information; and
an image stream management module, executable by the processor, to:
enable a user to create a custom image album via a computer-implemented user interface, the image album including a link to at least one social network account having a plurality of images stored therein;
provide an application on a rendering device to support an image stream; and
automatically, periodically, and directly stream the plurality of images via a network from the social network account to the application on the rendering device of a user platform.

12. The system as claimed in claim 11 being further configured to enable the user to select images from an image collection of a friend of the user, the friend of the user being a user in a friend relationship with the user as established on a social network site.

13. The system as claimed in claim 11 being further configured to enable the user to select images from an image collection of a followed user, entity, or group, the followed user, entity, or group being a user, entity, or group in a followed relationship with the user as established on a social network site.

14. The system as claimed in claim 11 being further configured to enable the user to select images from an image collection with liked pages, the liked pages being established in connection with a social network site.

15. The system as claimed in claim 11 wherein the rendering device of the user platform is from the group: an electronic picture frame device, a consumer electronic device, a computer, a mobile device, and a television.

16. The system as claimed in claim 11 wherein the application on the rendering device is a screensaver application.

17. The system as claimed in claim 11 wherein the application on the rendering device is a device application.

18. The system as claimed in claim 11 being further configured to automatically, periodically, and directly stream a plurality of advertisements via the network to the application on the rendering device of the user platform.

19. The system as claimed in claim 11 being further configured to create an event album and enable users to post images directly to the event album.

20. A non-transitory machine-useable storage medium embodying instructions which, when executed by a machine, cause the machine to:
enable a user to create a custom image album via a computer-implemented user interface, the image album including a link to at least one social network account having a plurality of images stored therein;
provide an application on a rendering device to support an image stream; and
automatically, periodically, and directly stream the plurality of images via a network from the social network account to the application on the rendering device of a user platform.
